(19) United States
(12) Patent Application Publication
(10) Pub. No.: US 2008/0016237 A1
(43) Pub. Date: Jan. 17, 2008

(54) HYBRID PLAYER FOR STREAMING AUDIO

(75) Inventors: Alexey Oraevsky, Waterloo (CA); Andrei Grichine, Kitchener (CA); Alexander Simonov, (US); Alexey Martynov, Sarov (RU)

Correspondence Address: DARYL W SCHNURR;MILLER THOMSON LLP, ACCELERATOR BUILDING, 295 HAGEY BLVD., SUITE 300, WATERLOO, ON, N2L 6R5, US

(73) Assignee: Sound Genetics Inc.

(21) Appl. No.: 11/770,513

(22) Filed: Jun. 28, 2007

Related U.S. Application Data
(60) Provisional application No. 60/806,100, filed on Jun. 28, 2006.

(51) Int. Cl. G06F 15/16

(52) U.S. Cl. 709/231

(57) ABSTRACT

A hybrid player and a method of using the hybrid player to play a first stream and a second stream simultaneously while muting the second stream. The first stream continues to play until it is desired to replace the first stream with the second stream. Simultaneously, the first stream is muted and the second stream is unmated while simultaneously increasing a volume of the second stream.

Applicant claims the benefit of U.S. Provisional Application Ser. No. 60/806,100 filed on Jun. 28, 2006

### BACKGROUND OF THE INVENTION

1. Field of the Invention

This invention relates to a method of coherent receiving and playback of multiple streaming audio. In particular, this invention provides a hybrid player and a method for seamless integration of multiple audio streams into single uninterrupted continuous audio playback at the receiving end.

2. Description of the Prior Art

In order to deliver an audio commercial or replace one content with another content during audio transmission, continuous data flow from one source gets interrupted so that signal from another source of data can be processed and played. This behaviour causes temporary loss of audible signal and provides an unpleasant listening experience to a listener due to the time delay that occurs when switching from one content to another content. A long pause without any audio signal can be very annoying to listeners. For example, in satellite radio transmissions or transmissions over the internet, long silent pauses can exist when the content provider is replacing one content with another content.

### SUMMARY OF THE INVENTION

The present invention provides a method to integrate multiple coherent streams and seamlessly infuse one into another in real time without causing loss of audible signal. The method of the invention may also be used to provide content removal and replacement from live internet audio feed in accordance to the “AFTRA” ruling.

It is an object of the present invention to provide a hybrid player and to provide a method of coherent receiving in playback of multiple streaming audio whereby two or more audio streams are loaded simultaneously into a hybrid player with one of the streams being audible and the other stream being muted. When it is desired to replace one stream with another stream, the volume of the first stream is muted and the volume of the second stream is unmuted simultaneously for a smooth transition without any long silent pause.

A method of moving from a first audio stream to a second audio stream without loss of audible signal comprises loading the first stream and the second stream into a hybrid player, playing the streams simultaneously while muting the second stream, continuing to simultaneously play the streams until the first stream approaches a termination point. At the termination point, the method comprises muting the first stream and unmuting the second stream while simultaneously increasing the volume of the second stream, thereby audibly moving from the first stream to the second stream without interruption in the audible signal.

A method of moving from one audible stream to another audible stream of multiple streams without loss of audible signal comprises loading two or more audio streams into a hybrid player while muting all of the streams but one. When it is desired to move to a new stream, muting the audible stream and unmuting another stream simultaneously.

A hybrid player for receiving and playing two audio streams simultaneously comprises a means for playing the streams simultaneously with a volume of a first stream being unmuted and a volume of a second stream being muted, the player being controllable to mute the volume of the first stream and unmute the volume of the second stream simultaneously when it is desired to audibly move from one stream to another.

A hybrid player can play two or more streams simultaneously while muting all of the streams but one, the hybrid player being controllable to change the one stream that is unmuted and streams that are muted.

### BRIEF DESCRIPTION OF THE DRAWINGS

FIG. 1 is a block diagram showing a hybrid player process; and

FIG. 2 is a front view of a hybrid player.

### DETAILED DESCRIPTION OF A PREFERRED EMBODIMENT

The proposed method is based on simultaneous use of multiple instances of an audio player and synchronized volume control over multiple streams.

In order to eliminate loss of audible signal two or more streams begin to simultaneously load each into correspondent instance of an audio player with muted volume leaving not muted only the stream which content is to be played first (typically this stream represents pushed commercial). A “pushed commercial” is an online commercial that cannot be deleted or prematurely terminated by a user. At the end of the initially played content, hybrid player processing module eliminates correspondent instance of the player from its processing graph and simultaneously gradually increase volume of the second live stream, etc—thus delivering uninterrupted continuous flow of audible signal providing a pleasurable listening experience.

While the hybrid player uses multiple instances of the audio player, it has single user GUI [graphical user interface] and set of controls that performs required functions to synchronously operate the streams.

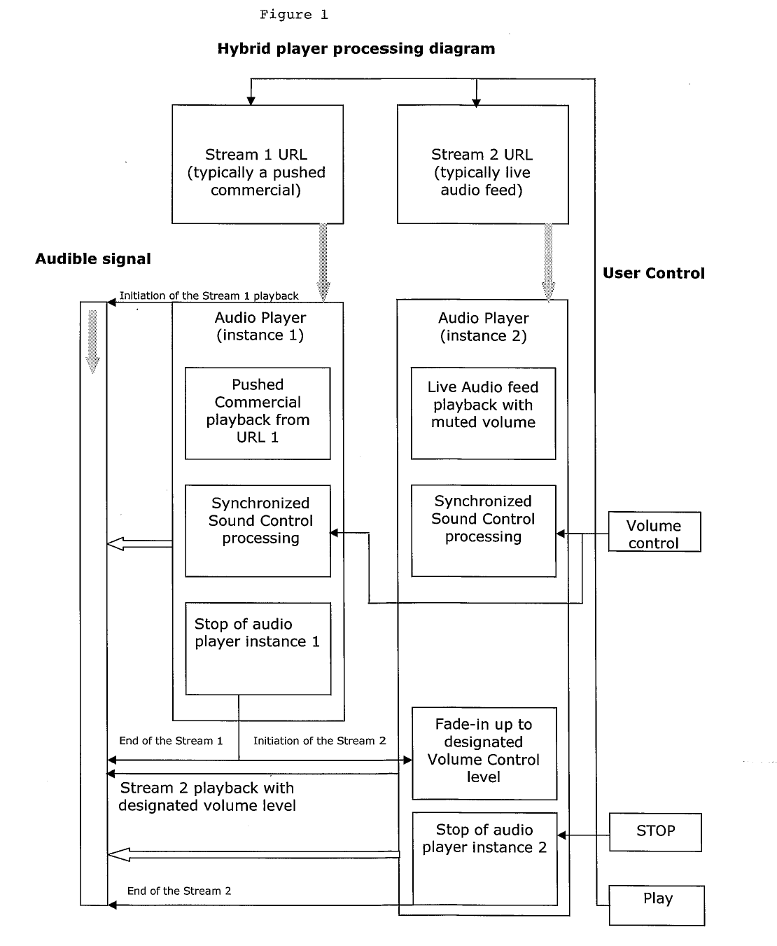

The proposed method operates in real-time using processing logic described in FIG. 1. The hybrid player can simultaneously play a first stream and a second stream with the first stream being unmuted and the second stream being muted. A controller changes the first stream to mute and the second stream to unmuted when it is desired to move from one stream to the other while avoiding a long silent pause. Alternatively, the hybrid player can play more than two streams simultaneously with all but one of the streams being muted. As a further alternative, the hybrid player can play any two streams of multiple streams simultaneously with one stream being muted and another stream being unmuted at any given time. A controller can simultaneously change one mute stream to unmute and the unmuted stream to mute as well as changing which streams are being played. When moving from a mute stream to an unmute stream, the hybrid player is controlled to be playing that stream before the change in order to avoid any long silent pauses. While the hybrid player and method of the present invention is preferably used with online audio signals over the internet, the player and method can be used with other audio signals as well. The hybrid player and one controller can be electronic versions created and controlled as computer software or they can be a combination of hardware and software versions. The termination point can be the end of a particular stream or it can be a point where a user desires the stream to end and to be replaced by another stream.

In FIG. 1, a hybrid player has two streams a first stream 1 and a second stream 2. The first stream is typically a commercial and the second stream is typically a live audio feed. The first stream is unmuted and the second stream is muted. A volume control allows a volume of said second stream to be controlled while said first stream is muted and vice versa. The first stream has a stop at which said first stream has a termination point. At said termination point, said first stream is muted and simultaneously said second stream is unmuted while simultaneously a volume of said second stream is increased. During the time when one of said streams is muted and another of said streams is unmuted, said muted stream can be replaced by a new muted stream. The new muted stream subsequently is unmuted when the other stream is muted while simultaneously increasing a volume of the stream that is unmuted.

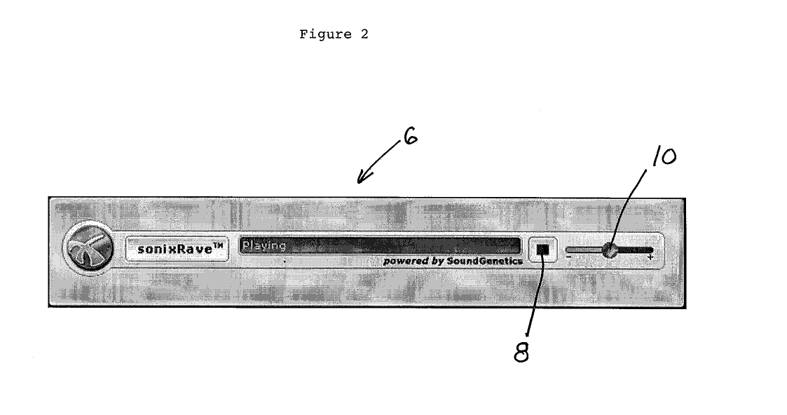

In FIG. 2, a hybrid player 6 has a power switch 8 and a volume control 10 allows the volume of the first stream to be adjusted as the sound stream is muted and vice versa.

While the hybrid player is described as having a first stream and a second stream, the hybrid player can be designed to have more than two streams where one of said streams is unmuted while a remainder of said streams is muted. The unmuted stream can be muted and simultaneously replaced with another stream by unmuting that stream while simultaneously increasing the volume of the unmuted stream.

We claim:

1. A method of moving from one audio stream to another audio stream of multiple streams without loss of audible signal, said audible streams being at least two streams, said at least two streams being at least a first stream and a second stream, said method comprising loading two or more audio streams into a hybrid player, playing at least two of said multiple audio streams simultaneously, muting all of said streams being played but said first stream, playing at least two of said streams and continuing to play said first stream to the desired termination point, at said termination point muting said first stream and unmuting said second stream, simultaneously increasing a volume of said second stream and repeating said method for further streams as desired without interruption in said audible signal by muting all of said audio streams except one.

2. A method of moving from a first audio stream to a second audio stream without loss of audible signal, said the method comprising, loading said first stream and said second stream into a hybrid player, playing said streams simultaneously while muting said second stream, continuing to play said streams, until said first stream approaches a termination point, at said termination point muting said first stream and unmuting said second stream while simultaneously increasing a volume of said second stream, thereby audibly moving from said first stream to said second stream without interruption in said audible signal.

3. A method as claimed in any one of claims 1 or 2 including the steps of continuing to play at least two of said streams after said termination point.

4. A method as claimed in any one of claims 1 or 2 including the step of replacing said first stream with a new first stream at or after said termination point.

5. A method as claimed in any one of claims 1 or 2 including the steps of repeating said method by subsequently simultaneously muting said second stream and unmuting said first stream at or before a termination point of said second stream.

6. A method as claimed in claim 2 including the step of replacing said first stream with a new first stream when said first stream in muted and ultimately muting said second stream and unmuting said first stream while simultaneously increasing a volume of said first stream.

7. A method as claimed in claim 1 including the step of using a feed for at least one of said streams that is a live internet audio feed.

8. A method as claimed in any one of claims 1 or 2 including the step of changing which streams are being heard by muting said second stream and unmuting said first stream.

9. A method as claimed in any one of claims 1 or 2 wherein said hybrid player and one controller can be electronic versions created and controlled as computer hardware or as a combination of hardware and software.

10. A method as claimed in any one of claims 1 or 2 wherein the termination point for any stream can be at the end of a particular stream or at a point where a user desires a stream to end and to be replaced by another stream.

11. A hybrid player for simultaneously playing at least two streams of a plurality of audio streams where one of the streams is unmute and a remainder of the streams are mute with a controller to simultaneously unmute a mute stream and mute an unmute stream.

12. A hybrid player as claimed in claim 11 wherein there are two streams, said two streams being a first audio stream and a second audio stream with said first audio stream being unmuted and said second audio stream being muted.

13. A hybrid player as claimed in claim 12 wherein any stream which is muted can be replaced with a new stream while said stream is muted.

14. A hybrid player as claimed in claim 11 wherein said hybrid player and said controller can be electronic versions created and controlled as computer software or a combination of hardware and software.

15. A hybrid player as claimed in claim 11 wherein at least one of said streams has a termination point that can be the end of a particular stream or it can be a point at which a user desires the stream to be muted and to be audibly replaced by another stream that is simultaneously unmuted.

16. A hybrid player as claimed in claim 11 for simultaneously playing two audio streams simultaneously, said player comprising means for playing a first audio stream and a second audio stream with the first audio stream being unmuted and the second audio stream being muted, a controller to simultaneously mute the first stream and unmute the second stream.
